(19) United States
(12) Patent Application Publication
(10) Pub. No.: US 2009/0173864 A1
(43) Pub. Date: Jul. 9, 2009

(54) APPARATUS FOR HOLDING COLLAPSIBLE TUBES

(76) Inventor: Donald Lee Wenskay, Encinitas, CA (US)

Correspondence Address: LAW OFFICE OF DONALD L. WENSKAY, 16909 VIA DE SANTA FE, 200, P.O. BOX 7206, RANCHO SANTA FE, CA, 92057, US

(21) Appl. No.: 11/970,453

(22) Filed: Jan. 7, 2008

(51) Int. Cl. B42F 13/00

(52) U.S. Cl. 248/339

(57) ABSTRACT

The present invention provides an apparatus for holding at least one collapsible tube. A retainer is adapted to be attached to the collapsible tube and a hanger is adapted to hold the retainer so as to bear the weight of the collapsible tube attached to the retainer.

### BACKGROUND OF THE INVENTION

The present invention relates to collapsible tubes and more particularly to an apparatus for organizing and mounting collapsible tubes.

Many products are sold and dispensed in collapsible tubes. These products include common household items such as toothpaste, lotions, ointments, salves, hair products, etc. Also, many products found in garages and used by the skilled trades are packaged in collapsible tubes, including glues, fillers, caulks, putty, etc.

It is not uncommon for a single household to possess dozens of such collapsible tubes in a single bathroom. Likewise, a typical garage or workshop may contain many different collapsible tubes. These numerous collapsible tubes are usually not stored in a central location throughout a home or a garage. For example, they may be stored in multiple drawers, cupboards, shelves, closets, desks, etc, adding to the clutter already common in such locations. As a result, for many persons, it is difficult to find a particular product in a collapsible tube when it is needed. This problem is compounded when persons neglect or forget to return the collapsible tube to its proper storage location after use. The result is time wasted searching for collapsible tubes. Often an individual may give up on the search and resort to buying another identical product, resulting in even more wasted time, along with money and resources wasted on the unnecessary purchase of another container of a product the consumer already owns. Among a large number of households, this may add up to a significant waste of time and resources.

As can be seen, there is a need for a way to organize collapsible tubes. There is a further need for a way to make it easy to locate a collapsible tube. There is also a need for a way to facilitate the returning of a collapsible tube to the same location after use.

### SUMMARY OF THE INVENTION

In one aspect of the present invention, an apparatus for holding at least one collapsible tube comprises: a retainer adapted to be attached to a collapsible tube; and a hanger adapted to hold the retainer so as to bear the weight of the collapsible tube attached to the retainer.

In another aspect of the present invention, a holder for a collapsible tube comprises: an elongated member; and a connector configured to be attached to a collapsible tube and also to the elongated member.

In a further aspect of the present invention, a collapsible tube mounting assembly comprises: a ring-shaped member; a mount for attaching the ring-shaped member to a vertical surface; and a plurality of connectors slidably attached at one end to the ring-shaped member, the connectors including a spring clip having first and second ends resiliently pressed toward each other by the spring.

In a further aspect of the invention a method of mounting at least one collapsible tube comprises: attaching an elongated member to a surface; attaching a connector to a collapsible tube; and attaching the connector to the elongated member such that the collapsible tube is suspended by the elongated member.

These and other features, aspects and advantages of the present invention will become better understood with reference to the following drawings, description and claims.

### BRIEF DESCRIPTION OF THE DRAWINGS

FIG. 1 shows a ring-shaped collapsible tube holder in accordance with one embodiment;

FIG. 2 shows a detailed view of the connector used in the embodiment shown in FIG. 1;

FIG. 3 shows a ring-shaped collapsible tube holder in accordance with another embodiment;

FIG. 3 shows a wall mounted linear collapsible tube holder in accordance with one embodiment;

FIG. 4 shows a wall mounted linear collapsible tube holder in accordance with one embodiment;

FIG. 5 shows a free-standing linear collapsible tube holder in accordance with one embodiment;

FIG. 6 shows ring-shaped collapsible tube holder in accordance with another embodiment;

FIG. 7 shows a collapsible tube holder that may be mounted on either a horizontal or a vertical surface in accordance with one embodiment;

FIG. 8a shows a connector attached to a collapsible tube in accordance with another embodiment; and

FIG. 8b shows another view of the connector shown in FIG. 8a.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention may be advantageously used in any location where collapsible tubes are stored, displayed and/or used. These locations may include homes, garages, manufacturing facilities, work sites where skilled trades are practiced, retail establishments, medical and professional offices, hospitals, clinics, schools, etc.

It may be particularly advantageous in locations where there are a large number of collapsible tubes stored and used and where efficiency and time saving are important.

Embodiments of the present invention may provide ways to store and hold one or more collapsible tubes in a single location. In the prior art, collapsible tubes were stored in numerous separate locations and were sometimes difficult to find. In contrast, the present invention facilitates the storage of multiple collapsible tubes in a single location. Further, the present invention makes it possible to store collapsible tubes in a location where they could not previously have been stored, such as hanging on a vertical surface such as a wall or a door. This allows the use of unused space and frees up space where the tubes were previously kept. Further, the present invention facilitates the returning of the collapsible tube to the same location after use. Also, in some embodiments, the collapsible tube needs not be removed from its holder and/or storage location during use.

Embodiments of the present invention provide a variety of ways to retain and store collapsible tubes including various configurations of racks and rings. These tube holders may be freestanding or may be hung, for example, from a hook on a wall or a door.

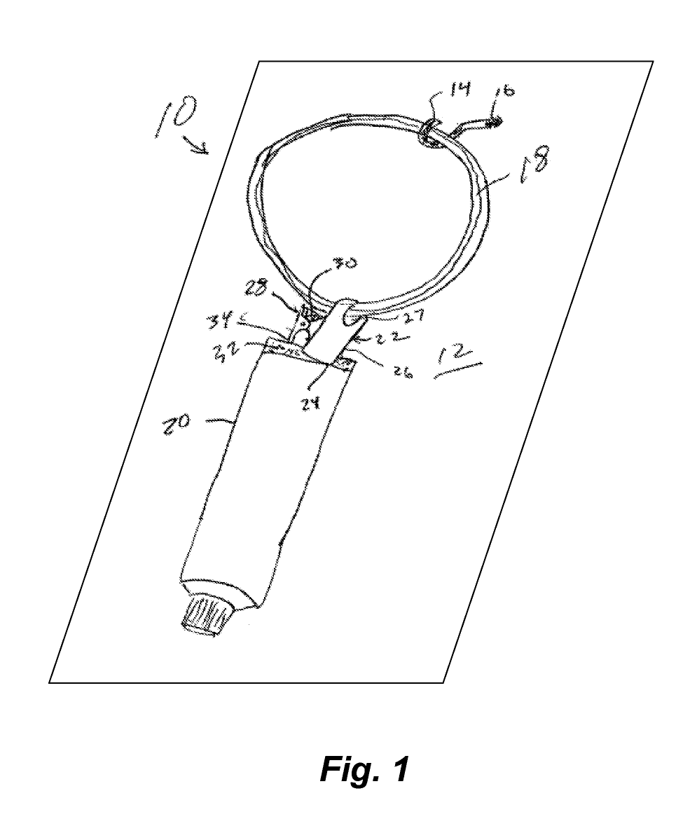

FIG. 1 shows a ring-shaped collapsible tube holder in accordance with an embodiment. The collapsible tube holder 10 may be mounted to a vertical surface 12, which may be the surface of a wall or the inside of a door or other object. A hook 14 may be affixed to the vertical surface. In the embodiment shown in FIG. 1, the hook has a threaded shaft 16 that is screwed into the surface 12. A variety of hooks may be used, such as plastic or metal hooks that may attach to the surface 12 by using adhesives or other means. Other means such as nails, screws brackets, etc. may also be used to attach the ring 18 to the surface 12. Ring 18, as shown in FIG. 1, may comprise a split ring such as those commonly used as key rings.

Ring 18 may be hung over the hanger 14 to facilitate the attachment and removal of the ring 18 from the hanger 14. In other embodiments, hanger 14 may encircle or otherwise fasten the ring 18 such that the ring is not easily removable. This may be preferred, for example, in applications where it is intended that the collapsible tube holder 10 will be used without removing the ring 18 from the hanger 14.

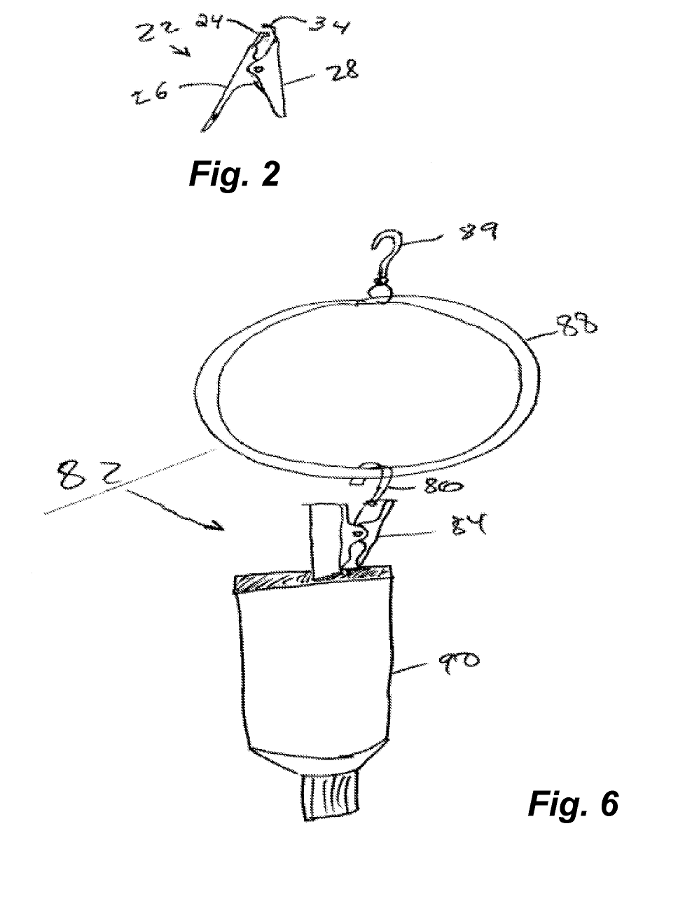

One or more collapsible tubes 20 may be attached to the ring 18 by means of a retainer or connector 22, which contains an opening 24 through which the ring 18 passes through. The connector 22, as shown in FIGS. 1 and 2 may comprise a conventional alligator or bulldog clip, such as those commonly used to attach lanyards and name tags. Connector 22 contains a spring 30 which causes a first end 24 of a first connector handle 26 and a second end 34 of a second connector handle 28 to press toward each other. Connector 22 is attached to the ring 18 by having the ring 18 pass through an opening 27 in the first connector handle 26.

To attach collapsible tube 20 to the connector 22, the crimped end 32 of the collapsible tube may be placed between the first end 24 and the second end 34 at a time when the first and second connector handles 26 and 28 are manually pressed together thereby spreading the first end 24 apart from the second end 34. When the handles are released, the resilient force of the spring 30 causes the collapsible tube 20 to be snugly attached between the first end 24 and the second end 34.

In some embodiments, such as shown in FIG. 2, the connector first end 24 is curved inward and overlaps the second end 34. That is, the first handle 26 is slightly longer than the second handle 28. Since the collapsible tube 20 is pliable, when placed between the first end 24 and the second end 34, the force of the spring 30 may cause the collapsible tube to be slightly deformed between the first end 24 and the second end 34. As a result, the strength of the attachment is significantly increased, thereby making it less likely that the collapsible tube will become unintentionally detached from the connector 22. The strength of attachment may be increased by manually pressing the first end 24 and the second end 34 together after attachment. This will serve to further deform the collapsible tube between these two ends.

Increased strength of attachment of the collapsible tube 20 to the connector 22 is particularly useful in some embodiments. For example, where the collapsible tube is large and heavy this increased strength may be needed to support the weight of the collapsible tube. Also, this increased strength may permit the user to grasp and use the collapsible tube 20 while it is still attached to the ring 18, along with several other collapsible tubes that may also be attached to the ring 18. In this case, the attachment between the connector 22 and the collapsible tube 20 may be strong enough to hold the weight of the ring 18 and a number of other collapsible tubes at the same time. An even stronger attachment may be achieved by the addition of a barb (not shown) to the first and second ends 24 and 34, which may be disposed so as to puncture the crimped end 32 of the collapsible tube 20.

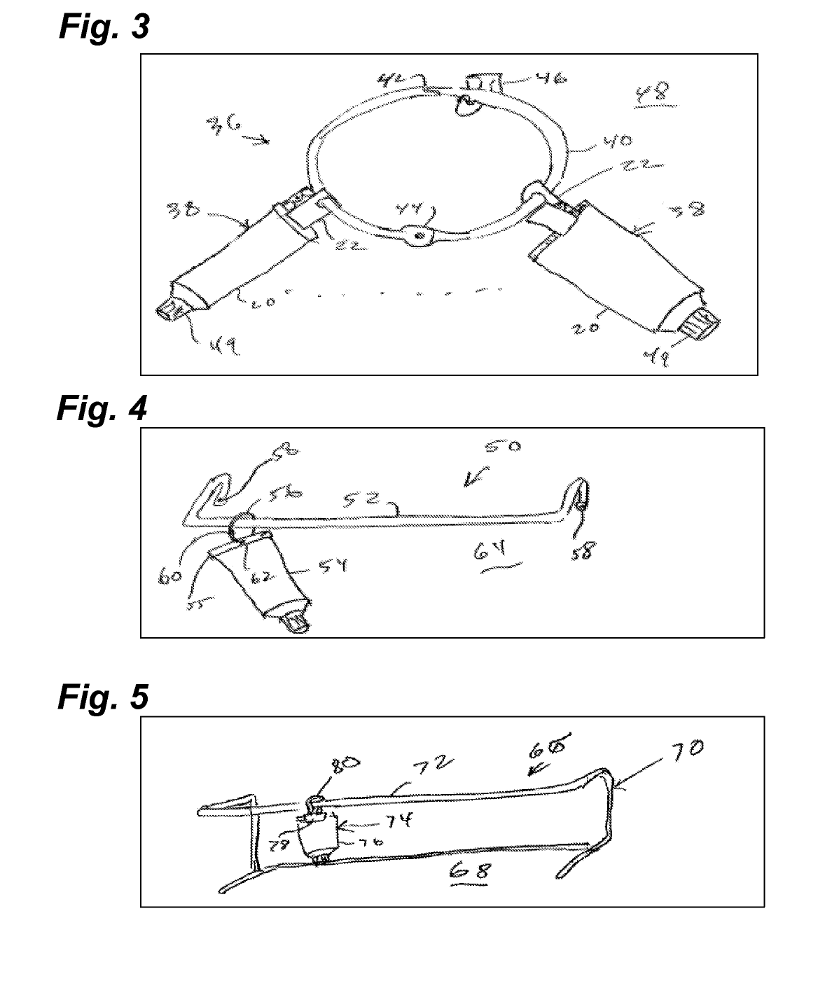

FIG. 3 shows an additional embodiment of a collapsible tube holder 36. A plurality of assemblies 38 each comprising a collapsible tube 20 and connector 22 may be attached to the ring 40. In this embodiment ring 40 may be a conventional binder ring (also known as a loose leaf ring) having opposing teeth 42 and a hinge 44 to facilitate the ease of removal and installation of assemblies 38. A hook 46 is used to attach the ring 40 to a vertical surface 48. Hook 46 in this embodiment may be a plastic hook attached to the vertical surface 48 by adhesive.

Note that there are a number of modes in which the collapsible tube holder 36 may be used. For example, the ring 40 with all the collapsible tubes attached may be easily removed from the surface 48 and carried to the site where the collapsible tube 20 is needed. Alternatively, the ring 40 may be left in place and the contents of the collapsible tube 20 may be dispensed with the tube cap 49 removed. In yet another mode, the collapsible tube is removed from the connector 22 and carried to the location where it is needed. In another embodiment, the ring 40 is not hung at all but is simply used to organize and transport the tubes.

FIG. 4 shows an embodiment of a collapsible tube holder 50 having a linear rack 52 holding a collapsible tube 54 by means of a ring connector 56. Ring connector 56 may be inserted through the crimped end 55 of the collapsible tube 54. For example, an end 60 of the ring connector may be sharp enough to puncture the crimped end 55 creating an opening 62. Alternatively, opening 62 may be created with the use of a hole punch (not shown). Rack 52 may be attached to a vertical surface 64 by means of screws 58.

FIG. 5 shows an embodiment of a collapsible tube holder 66 adapted to be free-standing on a horizontal surface 68. A metal or plastic rack 70 includes a horizontal bar 72 which holds the collapsible tube assembly 74. In this embodiment, the collapsible tube assembly includes a collapsible tube 76 and a connector 78. In this embodiment, the connector 78 comprises a conventional binder clip having a pair of wire handles 80. At least one of the wire handles 80 have the horizontal bar passing through it.

FIG. 6 shows an embodiment of a collapsible tube holder 82 wherein the connector 84 comprises a clip having a hook 86 attached thereto. Hook 86 is hooked over the ring 88 to carry the weight of the collapsible tube 90, to make it easier to remove the collapsible tube 90 from the ring 88. A hook 89 is attached to the ring 88 so that ring 88 may be hung from an object such as a towel rack (not shown) in situations where a hook, such as hook 46, is not available.

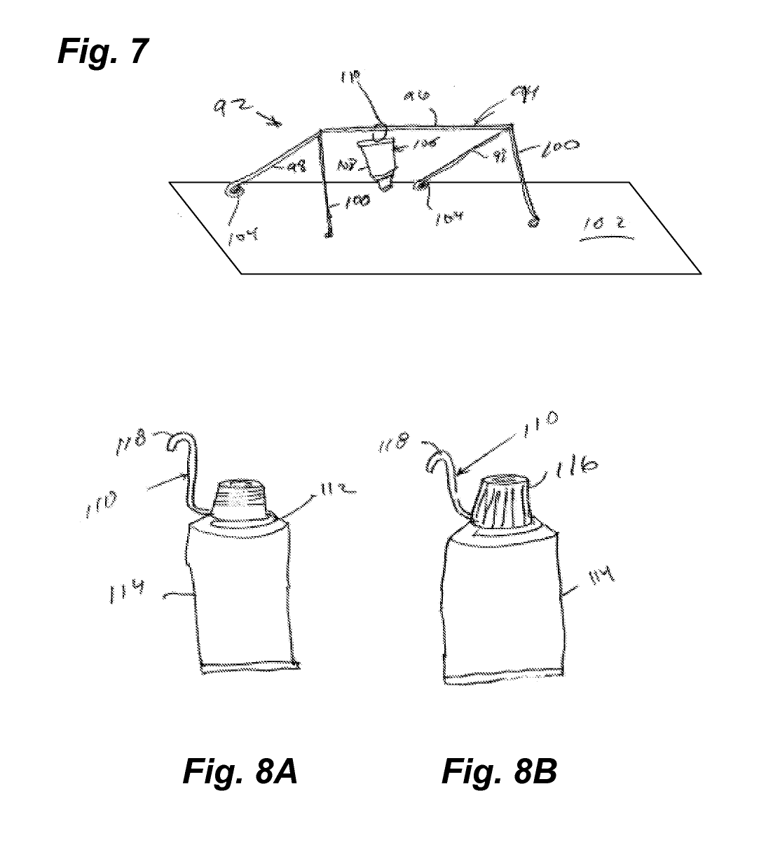

FIG. 7 shows and embodiment of a collapsible tube holder 92 which includes a rack 94 having a horizontal bar 96 attached to a first pair of legs 98 and a second pair of legs 100. A collapsible tube assembly 106 includes a collapsible tube 108 and a connector 110, which may comprise any of the previously mentioned connectors. Collapsible tube assembly 106 may be hung from the horizontal bar 96. In one embodiment, the legs 98 and 100 of the collapsible tube holder 92 rest on a surface 102 which comprises a horizontal surface. In another embodiment, the legs 98 are attached to the surface 102 by means of fasteners 104 which may be screws that may be inserted into the surface 102. This embodiment is useful where the surface 102 is a vertical surface. Note that the case where the surface 102 is vertical, the collapsible tube holder 92 will be disposed such that gravity will pull the collapsible tube 108 in a downward position parallel to the surface (not shown).

FIG. 8a shows a connector 110 that may be used with the above-described embodiments. Connector 110 includes a circular end 112 that wraps around the cap end of the collapsible tube 114, shown here with the cap removed. FIG. 8b shows the connector 110 attached to the collapsible tube 114 with a cap 116 in place. Note that the cap 116 may serve to retain the connector 110 in place. Alternatively, connector 110 may be retained in place by the tension created when it is wrapped around the collapsible tube 114. Connector 110 includes a hook 118 which may be hooked around, for example, the ring 18, or the horizontal bar 96 in the above-described embodiments.

Thus, it may be seen that embodiments of the present invention may provide a way to conveniently hold a plurality of collapsible tubes. The present invention may be used anywhere collapsible tubes are kept, such as in homes, garages, offices, hospitals, clinics, worksites, etc. The present invention may also be used in stores to display collapsible tubes that are for sale. Depending on the size of the embodiment, one or a large number of collapsible tubes may be held by the collapsible tube holder. By storing collapsible tubes in a central location, it is quicker and easier to find them, thereby saving time and effort. Also, by hanging the collapsible tubes from a vertical surface, such as the inside of a cupboard door, unused space is utilized, freeing up space in the locations formerly occupied by the tubes.

Another advantage of the invention is that it may be constructed from previously manufactured products, such as key rings, binder rings, lapel tag clips, etc. As a result, the present invention may be made inexpensively using these commonly found parts without the necessity of the expense of specially designing and manufacturing unique items.

It should be understood, of course, that the foregoing relates to exemplary embodiments of the invention and that modifications may be made without departing from the spirit and scope of the invention as set forth in the following claims.

We claim:

1. An apparatus for holding at least one collapsible tube comprising:
a retainer adapted to be attached to a collapsible tube; and
a hanger adapted to hold said retainer so as to bear the weight of said collapsible tube attached to said retainer.

2. The apparatus of claim 1 wherein said retainer comprises a clip removably attached to said collapsible tube, said clip being slidingly attached to said hanger at said other end.

3. The apparatus of claim 1 wherein said retainer comprises a ring-shaped retainer attached to said collapsible tube and having an opening through which said hanger passes.

4. The apparatus of claim 1 wherein said retainer has a hook-shaped first end adapted to be hooked over said hanger.

5. A holder for a collapsible tube comprising:
an elongated member; and
a connector configured to be attached to a collapsible tube and also to said elongated member.

6. The holder of claim 5 further comprising at least one additional connector configured to be attached to at least one additional collapsible tube and also connected to said elongated member.

7. The holder of claim 5 wherein said elongated member is a ring-shaped member.

8. The holder of claim 5 wherein said connector is removably attached to said elongated member, said connector also being configured to be removably attached to said collapsible tube.

9. The holder of claim 5 wherein said connector comprises a clip having a spring.

10. The holder of claim 9 wherein said clip comprises a clip having a first handle with a first end and a second handle with a second end, said first handle being longer that said second handle such that said first end overlaps said second end.

11. The holder of claim 10 wherein said collapsible tube is deformed when disposed between said first and second ends.

12. The holder of claim 5 wherein said connector has an opening through which said elongated member passes through.

13. The holder of claim 5 further comprising a mount for attaching said elongated member to a surface.

14. The holder of claim 10 wherein said mount is a hook.

15. The holder of claim 14 wherein said elongated member is linear.

16. The holder of claim 15 wherein said elongated member includes a stand connected, said stand configured to be disposed against a flat surface.

17. The holder of claim 16 wherein said flat surface is horizontal.

18. The holder of claim 16 wherein said flat surface is vertical.

19. The holder of claim 5 wherein said connector is configured to be attached to a crimped end of said collapsible tube.

20. The holder of claim 5 wherein said connector is attached to an end of said collapsible tube having an opening and a cap.

21. A collapsible tube mounting assembly comprising:
a ring-shaped member;
a mount for attaching said ring-shaped member to a vertical surface; and
a plurality of connectors slidably attached at one end to said ring-shaped member, said connectors including a spring clip having first and second ends resiliently pressed toward each other by said spring.

22. A method of mounting at least one collapsible tube comprising:
attaching an elongated member to a surface;
attaching a connector to a collapsible tube; and
attaching said connector to said elongated member such that said collapsible tube is suspended by said elongated member.

23. The method of claim 22 further comprising attaching at least one additional connector to at least one additional collapsible tube and attaching at said at least one additional connector to said elongated tube.
